(19) United States
(12) Patent Application Publication
(10) Pub. No.: US 2008/0028260 A1
(43) Pub. Date: Jan. 31, 2008

(54) Memory system

(76) Inventors: Mutsumi Oyagi, Kyoto (JP); Ryota Nishikawa, Shiga (JP)

Correspondence Address: MCDERMOTT WILL & EMERY LLP, 600 13TH STREET, NW, WASHINGTON, DC, 20005-3096, US

(21) Appl. No.: 11/806,879

(22) Filed: Jun. 5, 2007

(30) Foreign Application Priority Data
Jul. 26, 2006 (JP) 2006-203856

(51) Int. Cl. G06F 11/16

(52) U.S. Cl. 714/6; 714/E11.054

(57) ABSTRACT

A memory system includes a memory having memory banks each having a redundant region for repairing a defect. When a plurality of defects occur in one of the memory banks, at least one of the defects is repaired by using the redundant region of the memory bank with the defects and at least one other of the defects is repaired by using the redundant region of another of the memory banks.

### CROSS REFERENCE TO RELATED APPLICATIONS

The teachings of Japanese Patent Application JP 2006-203856, filed Jul. 26, 2006, are entirely incorporated herein by reference, inclusive of the claims, specification, and drawings.

### BACKGROUND OF THE INVENTION

The present invention relates to a memory system for repairing a defect in a memory.

Semiconductor memories that have been fabricated are subjected to a screening test. When a memory is determined to have a defective region by the test and the defective region is repaired, a method is used in an access to a memory in which it is determined whether or not an address inputted indicates the defective region in the memory and, when the inputted address indicates the defective region, the inputted address is converted to indicate a redundant region in the memory. To enable an efficient redundancy repair in a memory, a redundancy repair apparatus for a memory which performs a repair on a per address basis, not on a per column or row basis, is disclosed in, e.g., Japanese Laid-Open Patent Publication No. 2005-196843.

FIG. 5 is a block diagram showing a structure of the conventional redundancy repair apparatus for a memory. The redundancy repair apparatus for a memory of FIG. 5 includes redundant address generating means 502, a selector 503, a memory 504, and a redundant memory 505.

The redundant address generating means 502 holds defective addresses each indicating a defective portion in a memory and redundant addresses in the redundant memory corresponding to the defective addresses. When an input address 501 received by the redundant address generating means 502 does not coincide with any of the defective addresses held thereby, the redundant address generating means 502 outputs, to the selector 503, a select signal 506 indicating the selection of the input address 501 and the supply thereof to the memory 504. When the input address 501 received by the redundant address generating means 502 coincides with any of the defective addresses held thereby, the redundant address generating means 502 outputs, to the selector 503, the redundant address 507 corresponding to the defective address and the select signal 506 indicating the selection of the redundant address 507 and the supply thereof to the redundant memory 505.

By adopting such a structure, it is possible to repair a defect in a memory on a per address basis, reduce the capacity of a redundant memory, and perform an efficient redundancy repair.

However, the redundant repair apparatus of FIG. 5 has had a problem that the speed of a memory access decreases because it repairs each defect by address conversion even when the defect can be repaired by using, e.g., a fusing method without reducing the speed of a memory access.

The problem of a reduction in the speed of a memory access is also due to the fact that each memory access is performed after determining whether or not an accessed address coincides with any of the addresses of defective portions held by the address generating means.

There is also a problem that it is necessary to hold the same number of defective addresses and the same number of redundant addresses as the defective portions and the circuit area of the redundant address generating means, which holds the defective addresses, increases as the number of the defective addresses increases.

### SUMMARY OF THE INVENTION

It is therefore an object of the present invention to reliably repair a defect in a memory, while minimizing a reduction in access speed, in a memory system for repairing a defect with a redundant region. Another object of the present invention is to reduce the number of registers for storing defective portions.

Specifically, a memory system according to the present invention includes: a memory having memory banks each having a redundant region for repairing a defect, wherein, when a plurality of defects occur in one of the memory banks, at least one of the plurality of defects is repaired by using the redundant region of the memory bank with the plurality of defects and at least one other of the plurality of defects is repaired by using the redundant region of another of the memory banks.

The arrangement allows the plurality of defects occurred in one of the memory banks to be repaired by minimizing a reduction in the speed of a memory access.

Preferably, the at least one defect is repaired by a fusing method using the redundant region of the memory bank with the plurality of defects.

Preferably, the at least one other defect is repaired by converting an accessed address to an address of the redundant region of the other memory bank.

Preferably, each of the memory banks is preliminarily associated with another of the memory banks which repairs one of the plurality of defects occurred in the memory bank with the plurality of defects and, when the accessed address is converted, a bit in the address that is required to specify the memory bank corresponding to the memory bank with the plurality of defects is converted.

The arrangement allows a reduction in the number of bits to be converted in the address conversion by predetermining the other memory bank which repairs, when the plurality of defects occur, at least one of the defects.

Preferably, each of the memory banks is preliminarily associated with another of the memory banks capable of repairing the defect occurred in the memory bank with the plurality of defects and the memory bank corresponding to the memory bank with the plurality of defects is activated.

The arrangement allows a reduction in the number of banks to be activated by predetermining the other memory bank capable of repairing, when the plurality of defects occur, at least one of the defects.

Preferably, the memory system described above further includes: an address conversion circuit for converting a first address inputted to the memory system to a second address indicating the redundant region of the other memory bank which repairs, when a defect occurs in a region indicated by the first address, the defect in the region; a defective address register for holding an address indicating a region already repaired by the redundant region of the other memory bank and outputting an address corresponding to the memory bank indicated by an inputted bank select address; a hit signal generation circuit for outputting a hit signal which is valid when the address outputted from the defective address register coincides with a predetermined portion of the first address; and a selector for selecting data read from the memory with the second address when the hit signal is valid or selecting data read from the memory with the first address when the hit signal is invalid.

Preferably, in the memory system described above, the memory bank having the region indicated by the first address is preliminarily associated with the other memory bank which repairs, when the region indicated by the first address has a defect, the defect in the region, the memory system further including: a bank conversion circuit for converting the first address to the bank select address such that it indicates the preliminarily associated other memory bank and outputting the bank select address to the defective address register.

Preferably, the number of entries in the defective address register is determined by a repair size unit per which a defect is repaired.

The arrangement allows the number of the entries in the defective address register to be determined by determining the repair size unit per which the defect is repaired. As a result, the circuit scale of the defective address register can be adjusted.

Preferably, the number of the memory banks in the memory is Na (Na is an integer of not less than 2), each of the Na memory banks has the redundant region in which the number of the entries is Nb (Nb is a natural number), and, when a defect is repaired for every Nc entries (Nc is a natural number) in the memory, the defective address register has Na×Nb/Nc entries.

Preferably, each of the defective address register and the hit signal generation circuit performs a process independent of processes of reading the data from the memory.

The arrangement allows the determination of whether or not the address indicated by an access to the memory system corresponds to the defective region and the processes of reading the data from the memory bank to be performed independently of each other. As a result, the speed of a memory access can be improved.

Preferably, the memory performs a process of reading the data based on the first address and a process of reading the data based on the second address independently of each other.

Preferably, the address conversion circuit converts the first address to generate a plurality of the second addresses and the memory performs a process of reading the data based on the first address and a process of reading the data based on each of the plurality of second addresses independently of each other.

In accordance with the present invention, even when a plurality of defects occur in one of the memory banks, the defects can be repaired and a reduction in the speed of a memory access can be reduced. In addition, the scale of a circuit for repairing the defect can be reduced.

### BRIEF DESCRIPTION OF THE DRAWINGS

FIG. 1 is a block diagram showing a structure of a memory system according to an embodiment of the present invention;

FIG. 2 is an illustrative view showing a structure of the input address of FIG. 1;

FIG. 3 is an illustrative view showing the values of a redundant address when the input address has the values of FIG. 2;

FIG. 4 is an illustrative view showing the values of a bank select address when the input address has the values of FIG. 2; and

FIG. 5 is a block diagram showing a structure of a conventional memory redundancy repair apparatus.

### DETAILED DESCRIPTION OF THE INVENTION

Referring to the drawings, an embodiment of the present invention will be described herein below.

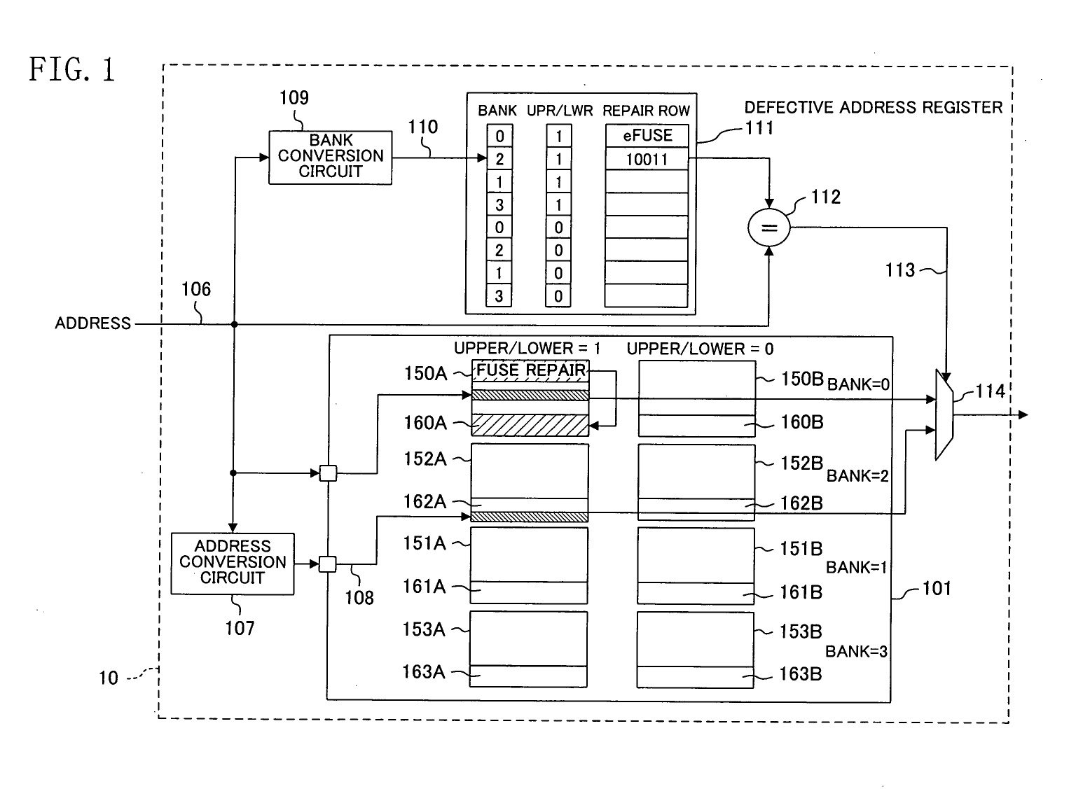

FIG. 1 is a block diagram showing a structure of a memory system 10 according to 20 the embodiment of the present invention. The memory system 10 of FIG. 1 includes a memory 101, an address conversion circuit 107, a bank conversion circuit 109, a defective address register 111; a hit signal generation circuit 112; and a selector 114. The memory system 10 receives an input address 106 given in the event of an access, reads data from the memory 101, and outputs the read data.

The memory 101 has memory banks 150A, 150B, 151A, 151B, 152A, 152B, 153A, and 153B. To specify a vertical position, any of bank numbers 0, 1, 2, and 3 is used, while either of bank columns 1 and 0 is used to specify a horizontal position. By specifying any of the bank numbers and either of the bank columns, one of the memory banks is selected.

The memory banks 150A, 150B, 151A, 151B, 152A, 152B, 153A, and 153B have respective redundant regions 160A, 160B, 161A, 161B, 162A, 162B, 163A, and 163B.

The address conversion circuit 107 converts the input address 106 received thereby to a redundant address 108 specifying any of the redundant regions 160A to 163B and outputs the redundant address 108. The memory 101 is accessed with the input address 106 and with the redundant address 108 and data accessed with the respective addresses can be read therefrom independently of each other.

The bank conversion circuit 109 converts the input address 106 to a bank selection address 110 for accessing the defective address register 111 and outputs the bank select address 110. The defective address register 111 holds defective addresses indicating defective portions repaired with the respective redundant regions 160A to 163B. The hit signal generation circuit 112 compares the defective address read from the defective address register 111 with a predetermined portion of the input address 106 and outputs a hit signal 113, which is valid when there is a coincidence therebetween or invalid when there is no coincidence therebetween.

The sequential process of generating the bank select address 110, reading the defective address from the defective address register 111, and outputting the hit signal 113 is performed independently of the processes of reading the data from the memory 101.

The selector 114 receives the data read with the input address 106 and the redundant address 108, selects the data read from the memory 101 with the redundant address 108 when the hit signal 113 is valid or selects the data read from the memory 101 with the input address 106 when the hit signal 113 is invalid, and outputs the selected data.

When a defect occurs in the memory 101, the memory system 10 repairs the defect by preferentially using a fusing method in the memory bank having the defect as long as it is possible. Since the fusing method physically disconnects a signal line in a fuse circuit and changes a region to which an address signal is given from a defective region to a redundant region, it prevents a reduction in the speed of a memory access.

When the redundant region provided in the memory bank with the defects is already used as a result of repairing another defective region by using the fusing method, the memory system 10 performs a repair by using the redundant region of the other memory bank preliminarily associated with the memory bank with the defects. In this case, it is assumed that the redundant region of the other preliminarily associated memory bank is not used (i.e., another defect is not repaired with the redundant region by using the fusing method).

Based on the foregoing assumption, a detailed description will be given herein below to each of the processes.

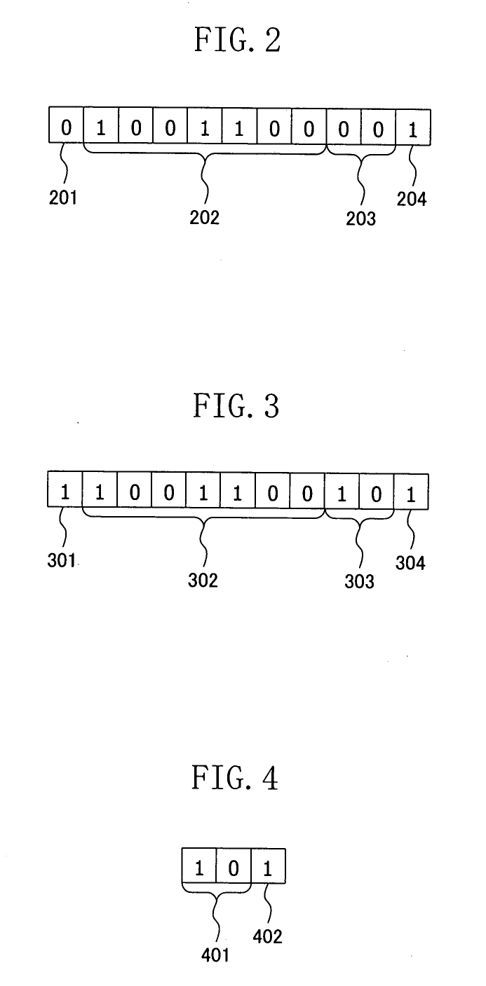

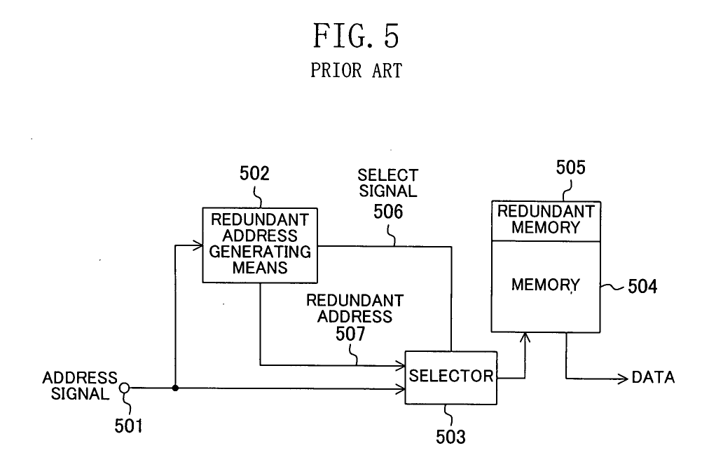

FIG. 2 is an illustrative view showing a structure of the input address 106 of FIG. 1. The input address 106 includes a flag bit 201, entry select bits 202, bank select bits 203, and an upper/lower select bit 204.

The flag bit 201 indicates whether or not any of the redundant regions 160A to 163B is to be accessed. When the flag bit 201 is set to 1, it indicates that any of the redundant regions is to be accessed. It is assumed that the flag bit 201 cannot be set to 1 by means of software such as a program. The entry select bits 202 indicate the entries in the memory bank. The bank select bits 203 indicate the bank number of the memory bank. The upper/lower select bit 204 indicates which one of the bank columns the memory bank belongs to.

It is assumed that, in the memory 101, the number of entries in each of the memory banks is 128 and the number of entries in each of the redundant regions is 4. It is also assumed that four entries amount to one repair size unit in the present embodiment, “0_{—}1001100_{—}00_{—}1” of FIG. 2 is given as the input address 106, and the region accessed with the address is defective.

FIG. 3 is an illustrative view showing the values of the redundant address 108 when the input address 106 has the values of FIG. 2. The redundant address 108 includes a flag bit 301, entry select bits 302, bank select bits 303, and an upper/lower select bit 304.

The address conversion circuit 107 sets 1 to the flag bit 301. When the redundant region of the memory bank indicated by the input address 106 is already used, the address conversion circuit 107 converts the bank select bits 203 and the upper/lower select bit 204 such that they specify the other memory bank preliminarily associated to repair a new defect and sets the resulting values respectively to the bank select bits 303 and the upper/lower select bit 304. By thus converting the input address 106, the address conversion circuit 107 generates the redundant address 108.

In the present embodiment, it is assumed that a defect is repaired by using the redundant region of an adjacent bank belonging to the same bank column in the memory 101. Accordingly, when the redundant region 160A of the memory bank 150A is already used as a result of repairing another defective region by using the fusing method, a defect is repaired by using the redundant region 162A of the memory bank 152A. As a result, when “0_{—}1001100_{—}00_{—}1” is given as the input address 106 as shown in FIG. 2, the address conversion circuit 107 changes the redundant address 108 to “1_{—}1001100_{—}10_{—}1”, as shown in FIG. 3.

FIG. 4 is an illustrative view showing the values of the bank select address 110 when the input address 106 has the values of FIG. 2. The bank select address 110 includes a bank select bit 401 and an upper/lower select bit 402.

The bank conversion circuit 109 converts the bank select bit 203 and the upper/lower select bit 204 in the received input address 106 in the same manner as the address conversion circuit 107. Specifically, when the redundant region of the memory bank indicated by the input address 106 is already used, the bank conversion circuit 109 sets the bank select bit 401 and the upper/lower select bit 402 such that they specify the other memory bank preliminarily associated to repair a new defect. When “0_{—}1001100_{—}00_{—}1” is given as the input address 106 as shown in FIG. 2, the bank conversion circuit 109 sets the bank select address 110 to “10_{—}1”, as shown in FIG. 4. By thus converting the input address 106, the bank conversion circuit 109 generates the bank select address 110.

The defective address register 111 holds the defective addresses indicating the defective portions repaired with the respective redundant regions of the memory banks. When the redundant region of the memory bank with a defect is already used, an address repaired with another memory bank is held in the defective address register 111. In the present embodiment, the number of entries in each of the redundant region is 4 and four entries amount to the repair size unit so that the defective address register 111 holds one defective address for each of the memory banks.

For example, according to FIG. 1, the data held by the defective address register 111 shows that a defect occurs in the memory bank 150A with the bank number 0 (bank=0) in the bank column 1 (upper/lower=1) and the redundant region 160A is used as a result of repairing the defect by using the fusing method. In addition, a new defect occurs in the region of the memory bank 150A indicated by the address “10011”. It is shown that, since the redundant region 160A is already used, the new defect is repaired with the redundant region 162A of the memory bank 152A with the bank number 2 in the bank column 1 that has been preliminarily associated with the memory bank 150A.

When the bank select address 110 is “10_{—}1” as shown in FIG. 4, it indicates the memory bank with the bank number 2 in the bank column 1 and “10011” is read from the defective address register 111, as shown in FIG. 1.

When the defective address read from the defective address register is “10011”, the regions indicated by the entries “10011_{—}00” to “10011_{—}11” are already repaired, since the number of the entries in each of the memory banks is 128. Therefore, as shown in FIGS. 1 and 2, when the entry select bit 202 in the input address 106 is “10011_{—}00” and the defective address read from the defective address register 111 is “10011”, the hit signal generation circuit 112 outputs the hit signal 113 which is valid.

In the memory 101, data is read from the memory bank 150A indicated by the address “0_{—}1001100_{—}00_{—}1” as the input address 106 and from the redundant region 162A indicated by the address “1_{—}1001100_{—}10_{—}1” as the redundant address 108. Since the hit signal 113 is valid, the region indicated by the input address 106 is a region where a defect has occurred and is repaired so that the selector 114 selects the data read with the redundant address 108.

By thus predetermining the bits to be converted in the address conversion circuit 107, the number of bits to be converted can be reduced so that it is possible to minimize a reduction in the speed of a memory access and reduce the circuit scale.

In addition, a memory bank having a redundant region capable of repairing a defect when it occurs in a specified memory bank may be predetermined and activated. As a result, it is possible to control the number of the memory banks to be simultaneously activated and reduce power consumption.

In the present embodiment, the memory 101 has the eight memory banks, the number of entries in each of the redundant regions is 4, and four entries amount to the repair size unit so that the number of entries in the defective address register 111 is 8. In the case where a defect is repaired by setting the number of memory banks to Na, setting the number of entries in each of the redundant regions to Nb, and using Nc entries in the memory as a repair size unit (Na is an integer of not less than 2 and each of Nb and Nc is a natural number), the defective address register 107 has Na*Nb/Nc entries.

By thus predetermining the repair size unit and the memory bank having the redundant region which repairs a region where a defect has occurred, the number of entries in the defective address register 111 is determined. Accordingly, by adjusting the number of entries in the defective address register 111, it is also possible to reduce the circuit area of the defective address register 111 and reduce a time required for address conversion.

In addition, the sequential process of generating the bank select address 110, reading the defective address from the defective address register 111, and outputting the hit signal 113 and the process of reading data from the memory 101 are performed independently of each other. As a result, it is possible to minimize the influence of each of the address conversion and the comparison between the input address and the defective address on the speed of a memory access.

Although the address conversion circuit 107 and the bank conversion circuit 109 are constructed as separate and discrete circuits in the present embodiment, it is also possible to cut out a part of the redundant address 108 resulting from the conversion by the address conversion circuit 107 and use it as the bank select address 110. This obviates the necessity for the bank conversion circuit 109 and allows a further reduction in circuit scale.

The other memory banks may be preliminarily associated with the memory bank indicated by the input address 106 to repair a new defect when the redundant region of the memory bank is already used. In this case, the address conversion circuit 107 generates a plurality of the redundant addresses 108 by converting the input address 106 received thereby and outputs the generated redundant addresses 108. The memory 101 is accessed with the input address 106 and with the plurality of redundant addresses 108 so that the data corresponding thereto is read from the memory 101. It is also possible to independently read the data accessed with the respective addresses.

As described above, since the present invention reduces the area of the circuit for holding defective addresses and minimizes a reduction in the speed of a memory access, it is useful for a system of which a reduction in circuit scale and a high-speed memory access are required.

What is claimed is:

1. A memory system comprising:
a memory having memory banks each having a redundant region for repairing a defect, wherein,
when a plurality of defects occur in one of the memory banks, at least one of the plurality of defects is repaired by using the redundant region of the memory bank with the plurality of defects and at least one other of the plurality of defects is repaired by using the redundant region of another of the memory banks.

2. The memory system of claim 1, wherein the at least one defect is repaired by a fusing method using the redundant region of the memory bank with the plurality of defects.

3. The memory system of claim 1, wherein the at least one other defect is repaired by converting an accessed address to an address of the redundant region of the other memory bank.

4. The memory system of claim 3, wherein each of the memory banks is preliminarily associated with another of the memory banks which repairs one of the plurality of defects occurred in the memory bank with the plurality of defects and, when the accessed address is converted, a bit in the address that is required to specify the memory bank corresponding to the memory bank with the plurality of defects is converted.

5. The memory system of claim 1, wherein each of the memory banks is preliminarily associated with another of the memory banks capable of repairing the defect occurred in the memory bank with the plurality of defects and the memory bank corresponding to the memory bank with the plurality of defects is activated.

6. The memory system of claim 1, further comprising:
an address conversion circuit for converting a first address inputted to the memory system to a second address indicating the redundant region of the other memory bank which repairs, when a defect occurs in a region indicated by the first address, the defect in the region;
a defective address register for holding an address indicating a region already repaired by the redundant region of the other memory bank and outputting an address corresponding to the memory bank indicated by an inputted bank select address;
a hit signal generation circuit for outputting a hit signal which is valid when the address outputted from the defective address register coincides with a predetermined portion of the first address; and
a selector for selecting data read from the memory with the second address when the hit signal is valid or selecting data read from the memory with the first address when the hit signal is invalid.

7. The memory system of claim 6, wherein
the memory bank having the region indicated by the first address is preliminarily associated with the other memory bank which repairs, when the region indicated by the first address has a defect, the defect in the region, the memory system further comprising:
a bank conversion circuit for converting the first address to the bank select address such that it indicates the preliminarily associated other memory bank and outputting the bank select address to the defective address register.

8. The memory system of claim 6, wherein the number of entries in the defective address register is determined by a repair size unit per which a defect is repaired.

9. The memory system of claim 6, wherein
the number of the memory banks in the memory is Na (Na is an integer of not less than 2),
each of the Na memory banks has the redundant region in which the number of the entries is Nb (Nb is a natural number), and,
when a defect is repaired for every Nc entries (Nc is a natural number) in the memory, the defective address register has Na×Nb/Nc entries.

10. The memory system of claim 6, wherein each of the defective address register and the hit signal generation circuit performs a process independent of processes of reading the data from the memory.

11. The memory system of claim 6, wherein the memory performs a process of reading the data based on the first address and a process of reading the data based on the second address independently of each other.

12. The memory system of claim 6, wherein
the address conversion circuit converts the first address to generate a plurality of the second addresses and
the memory performs a process of reading the data based on the first address and a process of reading the data based on each of the plurality of second addresses independently of each other.
